(19) United States
(12) Patent Application Publication
(10) Pub. No.: US 2025/0163259 A1
(43) Pub. Date: May 22, 2025

(54) ECO-FRIENDLY CARBOXYMETHYL CELLULOSE-BASED PREFORMED PARTICLE GELS FOR CONFORMANCE CONTROL IN OIL AND GAS RESERVOIRS

(71) Applicant: Qatar Foundation for Education, Science and Community Development, Doha (QA)

(72) Inventors: Ahmed Ben Ali, Doha (QA); Ahmed Hamza, Doha (QA); Ibnelwaleed A. Hussein, Doha (QA); Mohammed Saad, Doha (QA); Abdulaziz Almakimi, Doha (QA); Baojun Bai, Doha (QA)

(21) Appl. No.: 18/932,231

(22) Filed: Oct. 30, 2024

Related U.S. Application Data
(60) Provisional application No. 63/547,751, filed on Nov. 8, 2023.

(51) Int. Cl. C08L 51/02; C09K 8/42

(52) U.S. Cl. CPC C08L 51/02; C09K 8/426

(57) ABSTRACT

A polymer material comprising a crosslinked carboxymethyl cellulose and cationic polyacrylamide (“CMC/CPAM”) polymer.

### CROSS-REFERENCE TO RELATED APPLICATION

The present disclosure claims priority to U.S. Provisional Patent Application 63/547,751 having a filing date of Nov. 8, 2023, the entirety of which is incorporated herein.

### BACKGROUND

Most proposed and commercial preformed particle gels (“PPGs”) are synthetic polymers based on acrylamide monomer crosslinked with organic crosslinker like n,n′-methylene bisacrylamide (“MBA”), polyethylene glycol diacrylate (“PEGDA”), divinylbenzene (“DVB”), 1,6-hexanediol diacrylate or inorganic crosslinker like chromium, potassium, aluminum or both. Other monomers like acrylic acid, n,n′-dimethylacrylamide (“DMA”), styrene sulphonate, dimethyldiallylammonium chloride, 2-acrylamido-2-methylpropane sulfonic acid (“AMPS”) or additives like clay, silica, and graphene are added to the formulation to increase the swelling, resistance to high temperature and control the strength.

While PPGs can effectively block water flow, the injection of synthetic materials and hazardous chemicals into oil and gas reservoirs has long been controversial due to the potential damage to the reservoir and the environment. These non-biodegradable materials can remain in the reservoir for long periods, potentially leaching into the surrounding soil and water. This can harm the local ecosystem, including the contamination of water sources and the disruption of biological processes.

Biodegradability, renewability, nontoxicity, and low cost are exceptional properties found in polysaccharides. In particular, modified cellulose, known as carboxymethyl cellulose (“CMC”) can be used in various fields such as food, detergent, pharmaceuticals, adhesives, drilling muds, water treatment, paper, coatings, and textile industries. Only a few works have proposed PPGs made of polysaccharides. One such example includes developing a material using starch-graft-polyacrylamide loaded with nanosilica. Meanwhile, another method includes preparing alginate/polyacrylamide-based PPGs. In a third example, degradable PPGs have been introduced by blending chitosan and polyacrylamide.

Thus, there exists a need for a new synthetic PPG polymer, specifically a carboxymethyl cellulose and cationic polyacrylamide (“CMC/CPAM”) polymer.

### SUMMARY

In light of the disclosure herein and without limiting the disclosure in any way, in an aspect of the present disclosure, which may be combined with any other aspect listed herein unless specified otherwise, a crosslinked polyacrylamide grafted carboxymethyl cellulose material comprises a crosslinked structure.

In another aspect of the present disclosure, which may be combined with any other aspect listed herein unless specified otherwise, a polymer material comprises crosslinked carboxymethyl cellulose and cationic polyacrylamide (“CMC/CPAM”) polymer.

In another aspect of the present disclosure, which may be combined with any other aspect listed herein unless specified otherwise, the polymer material is a preformed particle gel (“PPG”).

In another aspect of the present disclosure, which may be combined with any other aspect listed herein unless specified otherwise, the polymer material further includes n,n′-methylene bisacrylamide (“MBA”).

In another aspect of the present disclosure, which may be combined with any other aspect listed herein unless specified otherwise, MBA is approximately 1% of the weight of the polymer material.

In another aspect of the present disclosure, which may be combined with any other aspect listed herein unless specified otherwise, particles of the polymer material have a diameter between approximately 375 μm to 879 μm.

In another aspect of the present disclosure, which may be combined with any other aspect listed herein unless specified otherwise, the storage modulus of the polymer material is between approximately 1000 Pa to 2600 Pa.

In another aspect of the present disclosure, which may be combined with any other aspect listed herein unless specified otherwise, the polymer material has a swelling range between approximately 15 g/g to 20 g/g.

In another aspect of the present disclosure, which may be combined with any other aspect listed herein unless specified otherwise, the polymer material has a strength between approximately 250 Pa to 1000 Pa.

In another aspect of the present disclosure, which may be combined with any other aspect listed herein unless specified otherwise, MBA is approximately 5% of the weight of the polymer material.

In another aspect of the present disclosure, which may be combined with any other aspect listed herein unless specified otherwise, particles of the polymer material have a diameter between approximately 375 μm to 850 μm.

In another aspect of the present disclosure, which may be combined with any other aspect listed herein unless specified otherwise, the storage modulus of the polymer material is between approximately 4000 Pa to 6000 Pa.

In another aspect of the present disclosure, which may be combined with any other aspect listed herein unless specified otherwise, the polymer material has a swelling range between approximately 15 g/g to 30 g/g.

In another aspect of the present disclosure, which may be combined with any other aspect listed herein unless specified otherwise, the polymer material has a strength between approximately 250 Pa to 1200 Pa.

In another aspect of the present disclosure, which may be combined with any other aspect listed herein unless specified otherwise, MBA is approximately 10% of the weight of the polymer material.

In another aspect of the present disclosure, which may be combined with any other aspect listed herein unless specified otherwise, particles of the polymer material have a diameter between approximately 375 μm to 700 μm.

In another aspect of the present disclosure, which may be combined with any other aspect listed herein unless specified otherwise, the storage modulus of the polymer material is between approximately 5000 Pa to 10000 Pa.

In another aspect of the present disclosure, which may be combined with any other aspect listed herein unless specified otherwise, the polymer material has a swelling range between approximately 5 g/g to 15 g/g.

In another aspect of the present disclosure, which may be combined with any other aspect listed herein unless specified otherwise, the polymer material has a strength between approximately 4000 Pa to 9000 Pa.

In another aspect of the present disclosure, which may be combined with any other aspect listed herein unless specified otherwise, the polymer material has irregular angular granules with microporous structures.

In another aspect of the present disclosure, which may be combined with any other aspect listed herein unless specified otherwise, the microporous structures include pores of differing sizes.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

The patent or application file contains at least one drawing executed in color. Copies of this patent or patent application publication with color drawing(s) will be provided by the Office upon request and payment of the necessary fee.

Features and advantages of the present disclosure, including a synthesized CMC/CPAM structure, described herein may be better understood by reference to the accompanying drawings in which:

FIG. 1 illustrates the proposed chemical structure and a schematic representation of CMC/CPAM, according to an embodiment of the present disclosure.

FIG. 2 is a graph illustrating the FTIR spectra of CMC and CMC/CPAM chemical structures with different MBA proportions, according to an embodiment of the present disclosure.

FIG. 3A is a graph illustrating the weight versus temperature for various CMC and CMC/CPAM chemical structures, according to an embodiment of the present disclosure.

FIG. 3B is a graph illustrating derivative thermogravimetry versus temperature for various CMC and CMC/CPAM chemical structures, according to an embodiment of the present disclosure.

FIG. 4 illustrates scanning electron microscope images of CMC, dried CMC/CPAM, and swelled CMC/CPAM in brine 2, according to an embodiment of the present disclosure.

FIG. 5 is a graph illustrating the effect of various chemical structures on the morphology structure of CMC/CPAM, according to an embodiment of the present disclosure.

FIG. 6A is a graph illustrating the effect of PPG compositions on the swelling kinetics at 25° C., according to an embodiment of the present disclosure.

FIG. 6B is a graph illustrating the effect of the particle size of PPG compositions at 25° C., according to an embodiment of the present disclosure.

FIG. 7 illustrates scanning electron microscope images of the swelled CMC/CPAM in brine 2 at different magnifications, according to an embodiment of the present disclosure.

FIG. 8 is a graph illustrating the impact of salinity on the strength of the CMC-based PPGs at 25° C., according to an embodiment of the present disclosure.

FIG. 9A is a graph illustrating the effect of temperature on the swelling of CMC-based PPGs at low and high reservoir temperatures, according to an embodiment of the present disclosure.

FIG. 9B is a graph illustrating the effect of temperature on the strength of CMC-based PPGs at low and high reservoir temperatures, according to an embodiment of the present disclosure.

FIG. 10A is a graph illustrating the influence of pH on the swelling of CMC-based PPGs in brine 2 at 25° C., according to an embodiment of the present disclosure.

FIG. 10B is a graph illustrating the influence of pH on the strength of CMC-based PPGs in brine 2 at 25° C., according to an embodiment of the present disclosure.

FIG. 11A is a graph illustrating the aging effect on the swelling of PPGs in brine 2 at 100° C., according to an embodiment of the present disclosure.

FIG. 11B is a graph illustrating the aging effect on the strength of PPGs in brine 2 at 100° C., according to an embodiment of the present disclosure.

FIG. 12 is a graph illustrating the effect of particles size on swelling and strength of 5% CMC/CPAM-based PPGs in brine 2 at 25° C., according to an embodiment of the present disclosure.

FIG. 13A illustrates the fracture preparation of a fractured core sample, according to an embodiment of the present disclosure.

FIG. 13B illustrates a fractured core sample during a test, according to an embodiment of the present disclosure.

FIG. 13C illustrates a fractured core sample after treatment, according to an embodiment of the present disclosure.

FIG. 14 is a graph illustrating a PPGs plugging performance test, according to an embodiment of the present disclosure.

FIG. 15 is a graph illustrating the post-treatment performance evaluation using water injection, according to an embodiment of the present disclosure.

The reader will appreciate the foregoing details, as well as others, upon considering the following detailed description of certain non-limiting embodiments of the present disclosure.

### DETAILED DESCRIPTION

The present disclosure is generally related to a crosslinked polyacrylamide grafted carboxymethyl cellulose polymer material comprising a crosslinked structure, specifically CMC/CPAM and processes for the synthesis of CMC/CPAM.

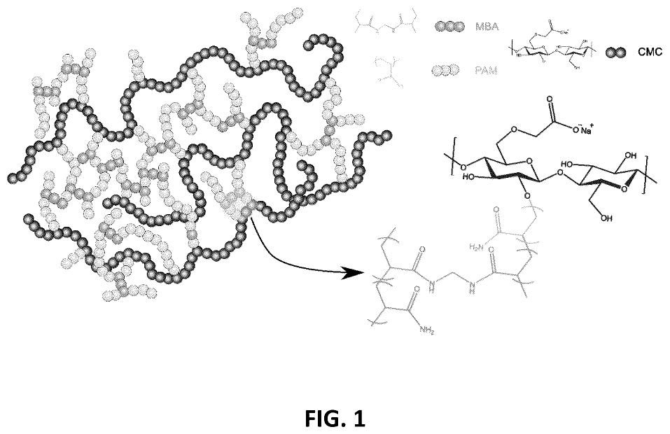

FIG. 1 illustrates the chemical structure and schematic representation of a synthesized PPG polymer which includes a carboxymethyl cellulose and cationic polyacrylamide polymer material.

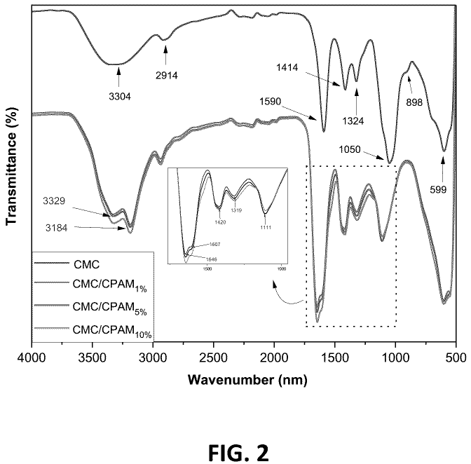

The chemical structure of the synthesized CMC/CPAM was confirmed by comparing its Fourier Transform Infrared Spectroscopy (“FTIR”) spectrum with carboxymethyl cellulose (“CMC”) as shown in FIG. 2. FIG. 2 includes transmittance data for CMC, CMC/CPAM_{1%}, CMC/CPAM_{5%}, and CMC/CPAM_{10%}, where the related CMC/CPAM percentage is indicative of chemical structures with different MBA proportions measured by weight percent of MBA. The CMC showed a broad band in the 3700-3000 cm⁻¹ region related to the stretching frequency of the —OH group. The peak at 2914 cm⁻¹ was assigned to C—H stretching vibration. The strong absorption bands at 1590 cm⁻¹ and 1414 cm⁻¹ were assigned to the asymmetric and symmetric stretching mode of carboxylate anion, and the peak around 1324 cm⁻¹ was due to O—H bending vibration. The characteristic of C—O vibrations from alcohol was observed at 1050 cm⁻¹, whereas β1-4 Glycoside bonds between glucose units were seen at 898 cm⁻¹. The FTIR spectrum of the CMC/CPAM indicates that AM and MBA were converted successfully since the C═C strong stretching peak between 995 and 900 cm⁻¹ was absent. The grafting of the monomers on the CMC backbone is confirmed by new peaks related to both PAM and MBA. The bands at 3184 cm⁻¹ and 3329 cm⁻¹ were ascribed to symmetric and asymmetric stretching of the N—H bond in the FTIR spectra of CMC/CPAM_{1%}, vibration bands at 1646 cm⁻¹ and 1607 cm⁻¹ were attributed to C═O stretching and N—H bending, whereas peaks at 1420 cm⁻¹ and 1319 cm⁻¹ were attributed to C—H bending and C—N stretching, respectively. It is well known that ether typically has a strong C—O stretch between 1000 and 1300 cm⁻¹. The shifting peak from 1050 cm⁻¹ to 1100 cm⁻¹ in CMC/CPAM_{1%} compared to CMC could be explained by the appearance of C—O—C groups resulting from the grafting reaction of hydroxyl functions with x-bond of PAM and MBA. Increasing the MBA proportion raises the intensity of C═O, C—O, and N—H bands in CMC/CPAM_{5%} and CMC/CPAM_{10%} since MBA contains two —CONH groups.

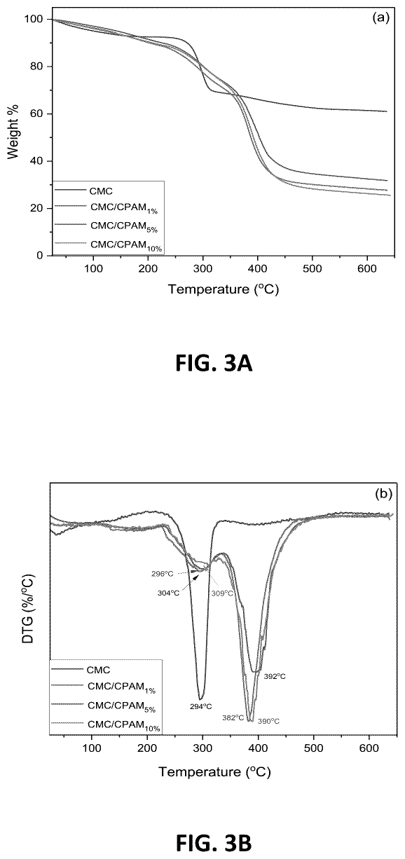

The thermal stability of CMC/CPAM was measured by a thermogravimetric analysis (“TGA”) and derivative thermogravimetry (“DTG”). The TGA and DTG curves of CMC and CMC/CPAM with different MBA ratios are depicted in FIGS. 3A and 3B, respectively. The weight loss in CMC and CMC/CPAM occurs primarily through dehydration and degradation. The initial mass loss of CMC (7.3%) and grafted materials (between 9-10%) is due to moisture. The second loss in CMC is between 225-330° C. due to the decarboxylation. The second decomposition of CMC/CPAM is for the degradation of both CMC and crosslinked PAM in the form of ammonia, forming imide groups via cyclization. The successive weight loss of about 37.6 wt % for CMC/CPAM_{1%}, 41.9 wt % for CMC/CPAM_{5%}, and around 44.4 wt % for CMC/CPAM_{10%}, happen at a temperature of T_{d}=382-392° C. and could be explained by the decomposition of the cyclized product. The synthesized PPGs had more residue (26-32%) than CMC (61%) after heating to 600° C. The grafting of crosslinked polyacrylamide chains onto CMC did not cause a significant change in the thermal stability.

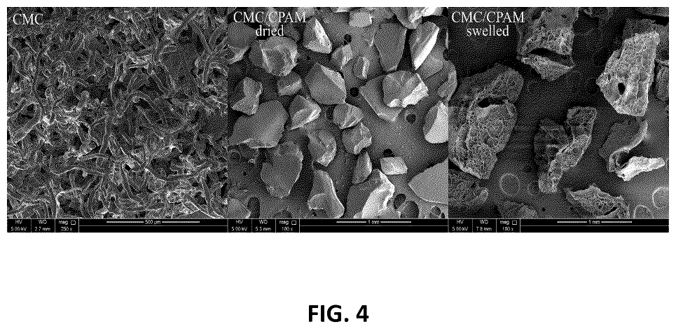

The surface morphologies and microstructures of CMC and CMC/CPAM in dried and after swelling are illustrated in FIG. 4. The CMC/CPAM appeared as irregular angular granules with rough surfaces and microporous structures, different from the fibrillar surface of CMC. These changes confirmed the grafting reaction and the creation of a 3D network upon crosslinking, verifying the proposed structure in FIG. 3. The absence of pores is evident in the dried state of the superabsorbent. Only upon swelling do the pores become visible on the surface of the particles; those pores are responsible for the PPG's absorbency.

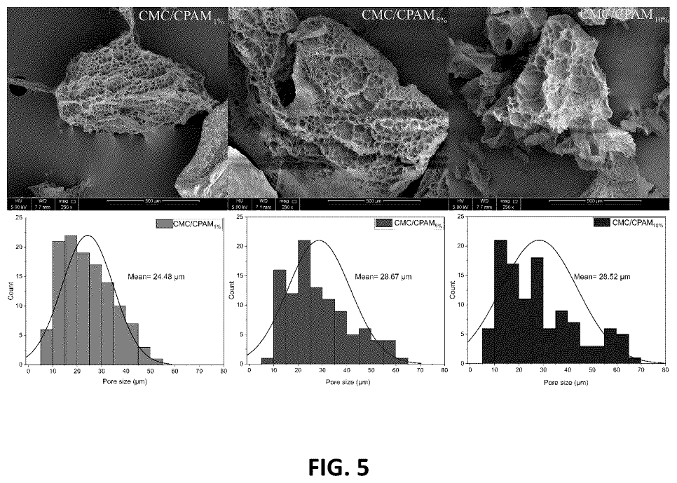

FIG. 5 shows the surface morphology and pore size distribution of CMC/CPAM at different MBA ratios after swelling in brine 2. Different pore shapes are visible with a broad range of sizes within the limit of 6 to 70 μm. CMC/CPAM_{1%} contains empty pores with an average of around 25 μm diameter. CMC/CPAM_{5%} contains both empty and filled pores. However, CMC/CPAM_{10%} has only filled pores representing a high crosslinking degree, averaging about 28 μm diameter.

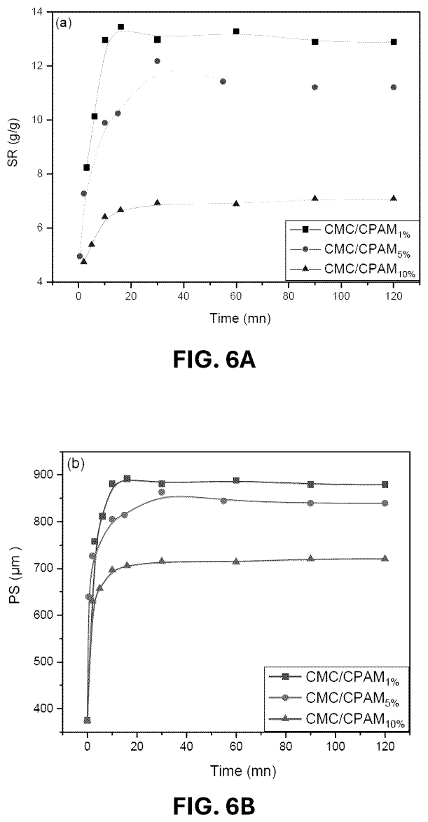

The kinetics of water absorption in saline water (brine 2) for the different proportions of CMC/CPAM is presented in FIG. 6A. The PPG samples exhibit a similar trend, where the swelling ratio substantially increases at the initial minutes. Then, the swelling rate decreases to reach equilibrium in about 30 minutes. The absorbency of the grafted materials was found in the following order: CMC/CPAM_{10%}<CMC/CPAM_{5%}<CMC/CPAM_{1%} with a maximum swelling ratio range between 7 g/g and 12.9 g/g. It is possible to observe that the MBA decreased the PPG's absorbency significantly when the weight ratio went from 5 to 10%, even so, it does not affect the swelling rate. The size of the swelled particles is presented in FIG. 6B. The continuous entry of water to the PPGs increases its diameter over time. CMC/CPAM_{1%} particles, for example, went from 375 μm in the dried state to around 879 μm in diameter after soaking in brine 2 for half an hour with a diameter ratio of about 2.34. The smallest size was recorded for CMC/CPAM 10% to be around 720 μm at room temperature (25° C.) with a diameter ratio 1.92. A fast kinetic is essential if the particles are injected into the reservoir fully swollen. If the treatment is limited to the near wellbore area and can be completed within a few hours, a fast swelling PPG with a high concentration is a viable choice. However, if the gel treatment aims to address issues further away from the wellbore, a PPG with a controllable swelling rate and lower concentration is preferable.

The absorbency of the three materials was also carried out at different salt concentrations such as DI water, 1% NaCl, and brine 1 with (TDS=33.65 g/L) at room temperature (25° C.). Table 1 illustrates all swelling capacity after 24 h:

TABLE 1
Salinity effect on the swelling ratio
of CMC/CPAM at room temperature

| Fluid type | CMC/CPAM_{1%} | CMC/CPAM_{5%} | CMC/CPAM_{10%} |
|---|---|---|---|
| DI water | 9.22 | 8.62 | 6.59 |
| 1% NaCl | 9.18 | 9.186 | 6.28 |
| Brine 1 | 9.32 | 7.55 | 6.41 |
| Brine 2 | 12.9 | 11.21 | 7.1 |

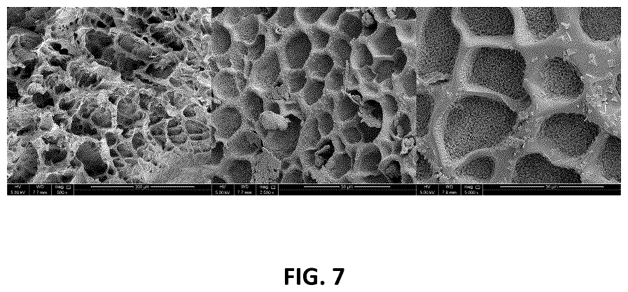

The absorbency of the materials was almost similar for the three solutions. The materials showed insensitivity to salts when compared to the absorbency in 1% NaCl, and brine 1 to DIW. This phenomenon can be attributed to the low charge screening effect related to the weak ionic group of CMC. The SR shows the highest value for brine 2, especially for CMC/CPAM_{1%}. This behavior may be related to the fact that the salt molecule started to be adsorbed on the surface of grafted CMC and fill in the pores at high salt concentrations, as shown in the SEM images of the PPGs (FIG. 7), increasing swollen particles weight. The adsorption feature makes the grafted valuable material in water treatment as they exemplify a good chemical and physical adsorption of dyes and metals. The abundance of —OH groups in polysaccharides, the high surface area, and the presence of chelating agents on the material all play a crucial role in adsorption. Most SAP undergoes shrinkage when exposed to salts, causing a reduction in particle size due to the inverse relationship between SR and salinity. However, in our particular case, the particle size of the material will remain unaffected by salinity, which is a desirable attribute. This means that the salinity of the injection fluid or formation water will no longer be a factor that could potentially affect the size of the prepared PPGs.

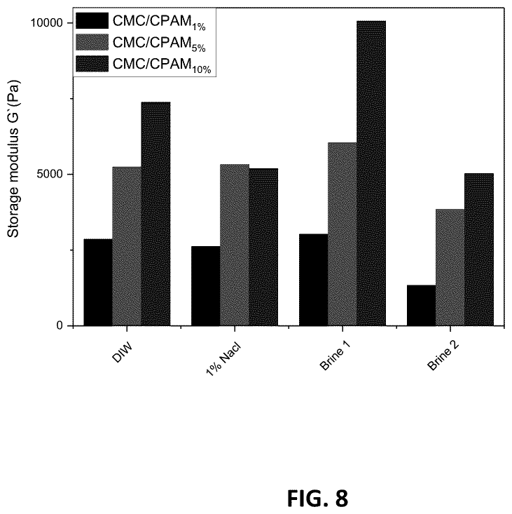

The impact of salts on the strength of the PPGs was investigated by exposing them to different salts that compose seawater and formation water in the oil and gas reservoirs. FIG. 8 shows the influence of the salinity degree of the aqueous medium on the strength of the PPGs at different MBA weight ratios in the range between 1-10 wt %. At first, the PPGs were immersed in deionized water and were allowed to swell to their maximum swelling capacity, which showed particle strength of 7380 Pa. The strength of the swelled particles in deionized water was compared to the swollen particles in sodium chloride and two different brines with low and high salinity. Adding NaCl at CMC/CPAM 1% did not have a major impact on the strength of the PPGs at low to medium MBA ratio (case of CMC/CPAM_{1%} and CMC/CPAM_{5%}). However, the strength of the particles showed a drop of 30% to 5190 Pa for CMC/CPAM_{10%}.

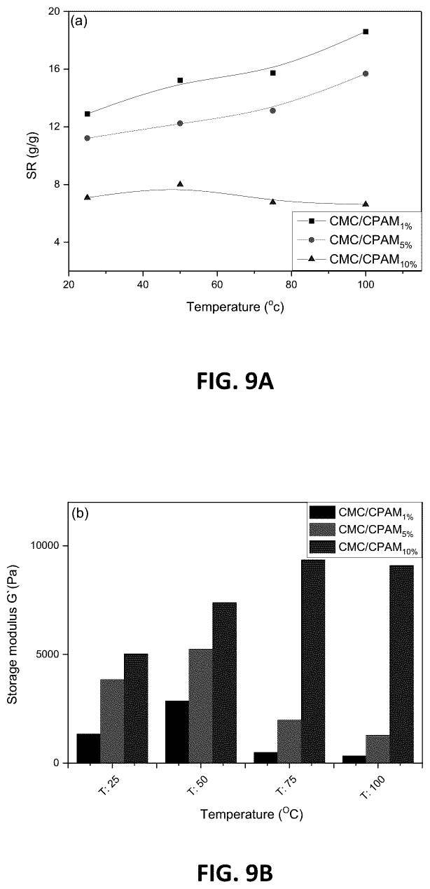

FIG. 9A indicates the results of the swelling ratio of PPGs under thermal effect in brine 2. The outcomes revealed that the swelling capacities of the two grafted materials CMC/CPAM_{1%} and CMC/CPAM_{5%} have significantly increased from 12.9 to 18.6 g/g and from 11.21 to 15.7 g/g with increasing the temperature from 25 to 100° C., respectively. High temperature can induce the expansion of a material structure, leading to grow its water uptake capacity. The direct relationship between the SR and temperature could also be explained by the thermal hydrolysis of acrylamide to acrylic acid, which expands its 3D structure and enhances its affinity to water. Furthermore, we can find that the swollen CMC/CPAM_{10%} sample shows stability in water retention capability when the temperature further increases to 100° C. It can be suspected that the high crosslinking degree along the gel network prevents its extension with the temperature.

The performance of the PPGs swelled in low salinity brine was studied at different temperatures from ambient conditions to 100° C. FIG. 9B shows the strength of the PPGs formed by different weight ratios of MBA. At a ratio of 1 to 5 wt %, increasing the temperature from 25 to 50° C. resulted in an increase of particles strength to a peak of 2856 and 5243 Pa at 25 and 50° C., respectively. Nevertheless, further increases in the temperature ratios led to a drop in the strength of PPGs (88% at 1 wt % and 75% at 5 wt % at 100° C.). In contrast, the strength of the PPGs particles improved from 5022 Pa at room temperature to 9351 Pa at 75° C., which is almost 86% growth. Increasing the temperature to 100° C. did not affect the CMC/CPAM_{10%} strength.

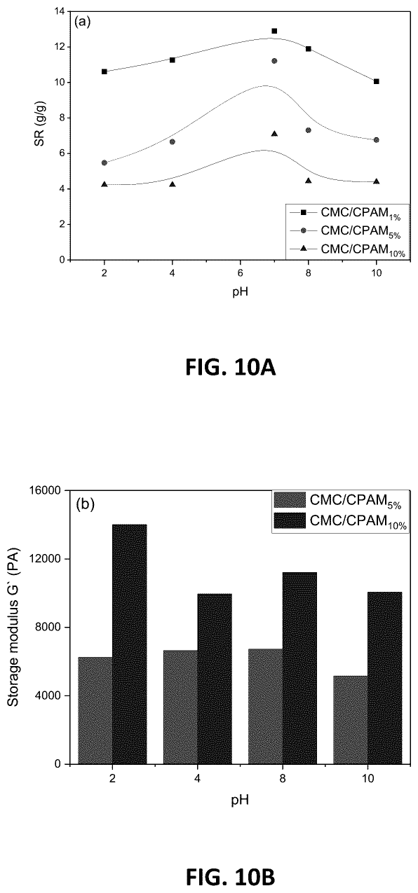

Equilibrium swelling for the prepared PPGs was studied in brine 2 at various pH solutions ranging from 2 to 10 (FIG. 10A). A progressive increment of swelling was observed with the increase of pH from 2 to 7.0 where a maximum swelling of 12.9 g/g was recorded for CMC/CPAM_{1%}; however, the swelling drops after further pH increase. The same behavior was observed in DIW with adjusted pH using a buffer solution. In acid medium, the partial protonation of carboxylate groups in CMC and amide group in PAM causes H-bond interactions between —COOH and —CONH₂ groups and electrostatic interaction between —COO⁻ and —NH₃⁺. In basic pH, the growing number of carboxylate functions increase the effect of salts where ions like Na⁺, Ca²⁺, and Mg²⁺ surround the —COO⁻ groups upon electrostatic binding. The interactions result in forming a compact structure and limit the interactions with water, causing a low swelling ratio compared to neutral pH. The impact of the pH (between 2 and 10) on the PPGs' strength has also been investigated. The results in FIG. 10B showed that changing the pH of the medium has no significant impact on the CMC/CPAM_{5%} at low and neutral pH. However, a slight drop in the PPGs strength (about 17%) was shown at high pH. In contrast, CMC/CPAM_{10%} revealed very high strength (about 14000 Pa) at a pH of 2, while the strength dropped by 28% to about 10053 Pa at a pH of 10. These results indicate that the PPGs at different MBA weight ratios have high stability at reservoir conditions of pH.

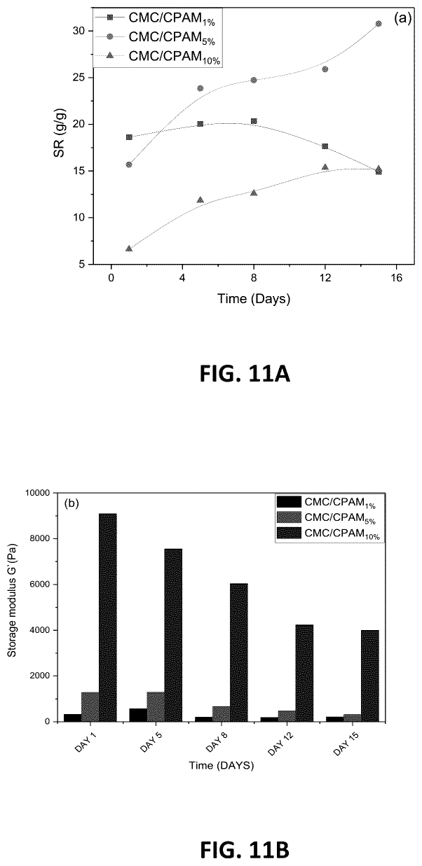

For a better approximation of CMC/CPAMs' behavior after aging in high-temperature, high-salinity reservoirs, in the long run, the PPGs were subjected to a constant temperature of 100° C. in high brine 2 at varying times. FIG. 11A illustrates that the SR of CMC/CPAM_{5%}, and CMC/CPAM_{10%} have raised on day 15 compared to day 1 by 96% and 129%, respectively. While CMC/CPAM_{1%}, has declined by 20%. Structural expansion with continuous thermal exposure leads to more absorbency. The compact structure may prevent water molecules from escaping the gel network and provide great water-holding capacity, while a weak structure leads to syneresis behavior or degradation.

The obtained results of storage modulus in FIG. 11B revealed that the PPGs lost their strength by various degrees after aging for 15 days. The PPGs formulated with 10 wt % MBA showed a drop of about 56% of their initial strength, whereas the highest reduction in the strength of the particle was for the PPGs that have 5 wt % MBA (75%). However, the storage modulus of the particles with 10 wt % MBA showed a reading of 3996 Pa after 15 days, still considered a high strength. On the other hand, the PPGs with low MBA concentration showed the lowest drop in strength after more than a fortnight. Nevertheless, these particles were initially weak with a storage modulus of 328 Pa only.

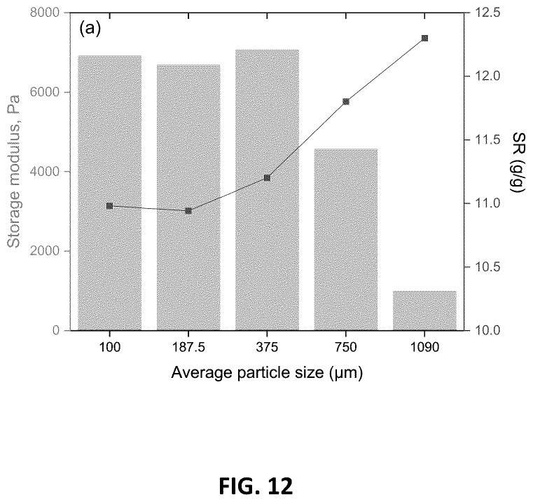

Particle size (“PS”) of CMC/CPAM was also investigated. Five groups of dry CMC/CPAM_{5%} powder were classified using different sieves sizes including 75-125 μm, 125-250 μm, 250-500 μm, 500-1000 μm, and 1000-1180 μm. The average dry PS was 100, 187.5, 375, 750, and 1090. After immersing the particles in brine 2 for 24 hr, the impact of the particle size on the swelling and strength of PPGs was investigated and the results are revealed in FIG. 12. The average swollen particle size (“SPS”) was subjected to a laser particle analyzer to collect the median diameter of the swollen particle size distribution D₁₀, D₅₀, and D₉₀, the results are collected in Table 2.

TABLE 2
Dry and swollen PS of CMC/CPAM_{5%} in
brine 2 by laser particle analyzer

| Mesh size | Avg. dry | SR | Calculated | PS (Analyzer) |
|---|---|---|---|---|
| (μm) | PS (μm) | (g/g) | PS (μm) | (μm) |
| 75-125 | 100 | 10.98 | 222.26 | D₁₀ = 56.74 |
| | | | | D₅₀ = 266.64 |
| | | | | D₉₀ = 497.51 |
| 125-250 | 187.5 | 10.94 | 416.24 | D₁₀ = 199.51 |
| | | | | D₅₀ = 620.22 |
| | | | | D₉₀ = 978.74 |
| 250-500 | 375 | 11.2 | 839.02 | D₁₀ = 246.78 |
| | | | | D₅₀ = 979.31 |
| | | | | D₉₀ = 1371.61 |

It is clear that the PPG particle size had no significant influence on water absorbency in region 75-500 μm and only a slight increase has been recorded for sizes above 500 μm. After contact with brine 2 solution, significant deviations are shown for the predicted particle size based on the SR and the median diameter D₅₀. The particle diameter increases by an average of 2.22 times based on a calculation and an average of 2.86 times according to the laser scattering spectrum analysis (Table 2). Micro-sized particles are primarily employed to reduce the permeability in the streaks/channels that are less than one Darcy while the millimeter-size particles are utilized for reservoirs with fractures in the form of channels or fractures with a permeability greater than a few Darcies. The selection process using different mesh diameters affects particle size distribution, especially if the dry particles have irregular shapes. However, two dry particles of the same size may not have the same SPS for the reason that the proportion and distribution of grafting and crosslinking are more likely diverse in the two particles, which affect the SR. 90% of dry particles in region 250-500 μm for example after swelling lie bellow the diameter of 1371 μm with 10% particles has a diameter less than 246.78 μm. This wide distribution may be desirable to achieve higher plugging efficiency because PPGs will have more access to pore sizes of the porous medium compared to PPGs with uniform sizes. PS selection is critical, especially when it comes to heterogeneous reservoirs. Oversized particles may cause injectivity problems by blocking low-permeability zones, while undersized particles possibly migrate out during successive water injection. PPGs can compress and deform to penetrate holes 20 times smaller than the diameter of the swollen particles, and hence, the largest diameter ratio of a swelled particle and a pore throat that the PPG can pass through depends on the swollen PPG strength. FIG. 12 revealed that increasing the size of the PPGs decreases the strength of these particles. PPGs between 75 μm and 500 μm showed an average storage modulus of approximately 6897 Pa and the strength dropped by a third and 85% when the average size of the PPGs was 750 and 1090 μm, respectively. Therefore, decreasing the PPGs size increases the strength of the particles; however, this is valid up to a size of 500 μm, and further decrease of the PPGs size did not show a significant improvement in the strength.

The plugging performance of CMC/CPAM-PPG was assessed by evaluating the ability of the placed gel to reduce the effective permeability of the fractured sandstone model (Table 3).

TABLE 3
Parameters of the plugging efficiency test

| | |
|---|---|
| PPG size (μm) | 250-600 |
| Swelling ratio | 10 |
| Brine | 2% KCl |
| Matrix permeability (md) | 93.31 |
| Matrix porosity (%) | 21.46 |
| Core length (cm) | 12.6 |
| Fracture width (mm) | 1.0 |
| Particle size to fracture width ratio | 0.79-1.89 |
| Storage modulus (Pa) | 2641 |
| Temperature (° C.) | 22 |

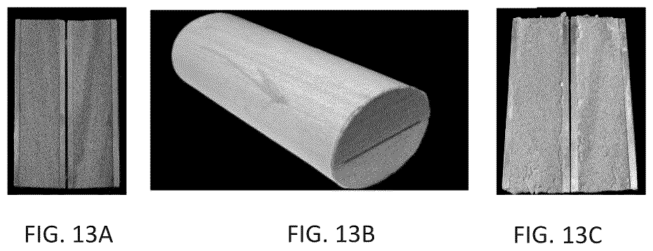

FIG. 13A illustrates the fracture preparation of a fractured core sample, FIG. 13B illustrates a fractured core sample during the plugging efficiency test, and FIG. 13C illustrates a fractured core sample after treatment.

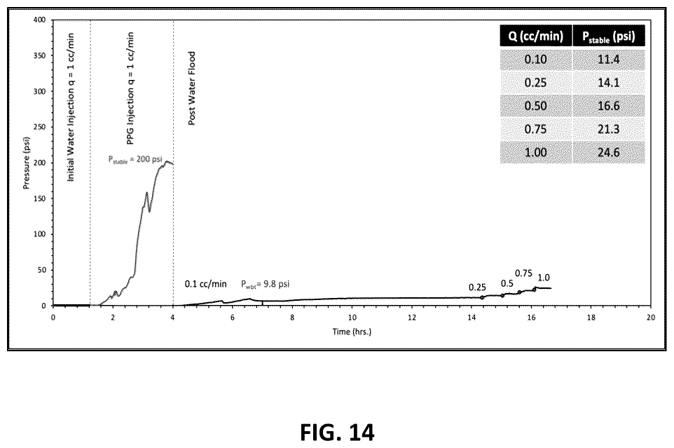

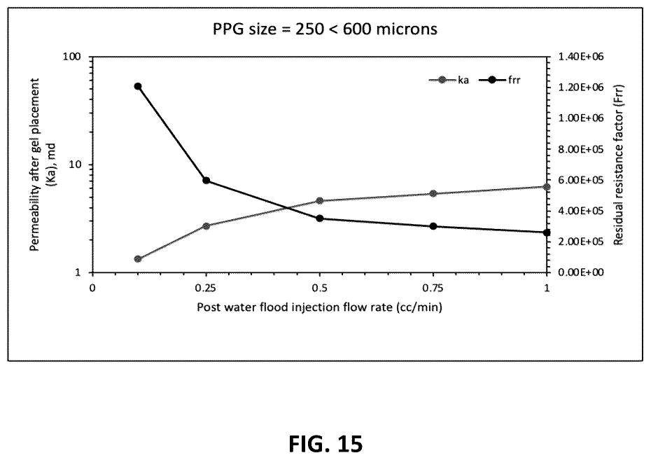

FIG. 14 illustrates three regions of the core flood experiment. The first region corresponds to the initial water injection phase, where the pressure is very low due to the high conductivity of the fracture compared to the matrix. Thus, most of the injected water will flow through the fracture. The second region represents the CMC/CPAM-PPG injection phase, characterized by increased pressure as the gel particles accumulate the fracture volume. When the gel particles began producing at the effluent at P=179 psi, the pressure increase slowed and eventually stabilized at P=200 psi. The third region is the post-water injection phase at different flow rates. This phase aims to determine the plugging efficiency of the packed PPG within the fracture. The injection started at a low flow rate of 0.10 cc/min until the water breakthrough occurred at P=9.8 psi, then left for a long time until the pressure stabilized at 11.4 psi. The injection flow rate was gradually increased until the pressure stabilized for each flow rate, to calculate the residual resistance factor Fr. Throughout the post-water injection phase, no gel was observed in the effluent, indicating no gel washout. FIG. 15 demonstrates that high Fᵣᵣ values indicate good plugging efficiency of CMC/CPAM-PPG in open fractures. Following the completion of the core flooding experiment, the fractured model was disassembled to assess the packing of CMC/CPAM-PPG particles within the fracture. The particles exhibited a well-packed configuration, and no whitish spots were observed, which could mean minor dehydration of the gel pack.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A polymer material comprising a crosslinked carboxymethyl cellulose and cationic polyacrylamide (“CMC/CPAM”) polymer.

2. The polymer of claim 1, wherein the polymer material is a preformed particle gel (“PPG”).

3. The polymer material of claim 1, wherein the polymer material further includes n,n′-methylene bisacrylamide (“MBA”).

4. The polymer material of claim 3, wherein MBA is approximately 1% of the weight of the polymer material.

5. The polymer material of claim 4, wherein particles material of the polymer have a diameter between approximately 375 μm to 879 μm.

6. The polymer material of claim 4, wherein the storage modulus of the polymer material is between approximately 1000 Pa to 2600 Pa.

7. The polymer material of claim 4, wherein the polymer material has a swelling range between approximately 15 g/g to 20 g/g.

8. The polymer material of claim 4, wherein the polymer material has a strength between approximately 250 Pa to 1000 Pa.

9. The polymer material of claim 3, wherein MBA is approximately 5% of the weight of the polymer material.

10. The polymer material of claim 9, wherein particles of the polymer material have a diameter between approximately 375 μm to 850 μm.

11. The polymer material of claim 9, wherein the storage modulus of the polymer material is between approximately 4000 Pa to 6000 Pa.

12. The polymer material of claim 9, wherein the polymer material has a swelling range between approximately 15 g/g to 30 g/g.

13. The polymer material of claim 9, wherein the polymer material has a strength between approximately 250 Pa to 1200 Pa.

14. The polymer material of claim 3, wherein MBA is approximately 10% of the weight of the polymer material.

15. The polymer material of claim 14, wherein particles of the polymer material have a diameter between approximately 375 μm to 700 μm.

16. The polymer material of claim 14, wherein the storage modulus of the polymer material is between approximately 5000 Pa to 10000 Pa.

17. The polymer material of claim 14, wherein the polymer material has a swelling range between approximately 5 g/g to 15 g/g.

18. The polymer material of claim 14, wherein the polymer has a strength between approximately 4000 Pa to 9000 Pa.

19. The polymer material of claim 1, wherein the polymer material has irregular angular granules with microporous structures.

20. The polymer material of claim 1, wherein the microporous structures include pores of differing sizes.
